(19) United States
(12) Patent Application Publication
(10) Pub. No.: US 2025/0308751 A1
(43) Pub. Date: Oct. 2, 2025

(54) COIL COMPONENT

(71) Applicant: Murata Manufacturing Co., Ltd., Kyoto-fu (JP)

(72) Inventors: Shigeto YAMAMOTO, Nagaokakyo-shi (JP); Shingo NAKAMOTO, Nagaokakyo-shi (JP)

(73) Assignee: Murata Manufacturing Co., Ltd., Kyoto-fu (JP)

(21) Appl. No.: 19/088,725

(22) Filed: Mar. 24, 2025

(30) Foreign Application Priority Data
Mar. 28, 2024 (JP) 2024-054666

(51) Int. Cl. H01F 27/28; H01F 17/04; H01F 27/29

(52) U.S. Cl. CPC H01F 27/2823; H01F 17/045; H01F 27/29

(57) ABSTRACT

A difference in the number of turns between first and second wires in contact with each other is changed without requiring a space in a direction along a central axis as much as possible. An (m−1)-th turn of a second wire includes a first portion that belongs to a first layer and is wound adjacent to an m-th turn of a first wire on a side of a second flange in a direction along a central axis. An m-th turn of the second wire includes a portion that belongs to a second layer and is wound from an outside in a direction orthogonal to the central axis on a valley portion between the m-th turn of the first wire and the first portion. An (m+1)-th turn of the second wire includes a portion that belongs to the second layer.

### CROSS-REFERENCE TO RELATED APPLICATION

This application claims benefit of priority to Japanese Patent Application No. 2024-054666, filed Mar. 28, 2024, the entire content of which is incorporated herein by reference.

### BACKGROUND

### Technical Field

The present disclosure relates to a coil component.

### Background Art

The coil component described in Japanese Patent Application Laid-Open No. 2018-120887 includes a winding core, a first flange, and a second flange. The winding core has a quadrangular prism shape. The first flange is connected to a first end of the winding core. The second flange is connected to a second end of the winding core. Further, the coil component includes four external electrodes, a first wire, and a second wire. Two of the four external electrodes are located on a surface of the first flange. The remaining two external electrodes are located on a surface of the second flange.

The first wire is wound around the winding core. The first end of the first wire is connected to the external electrode on the first flange. The second end of the first wire is connected to the external electrode on the second flange side. The second wire is wound around the winding core. The first end of the second wire is connected to the external electrode on the first flange. The second end of the second wire is connected to the external electrode on the second flange. The second wire is wound in the same direction as the first wire outside the first wire as a whole.

### SUMMARY

In the coil component as described in Japanese Patent Application Laid-Open No. 2018-120887, a stray capacitance may be generated at a portion where the wires are in contact with each other. In addition, the larger the difference in the number of turns between the first wire and the second wire at the contact portion, the larger the stray capacitance. The coil component described in Japanese Patent Application Laid-Open No. 2018-120887 includes a portion where the second wire and the first wire intersect with each other in order to change a difference in the number of turns between the first wire and the second wire in contact with each other. However, in the coil component described in WO 2017/061143 A1, a large space is required in the direction along the central axis in the vicinity of the intersection in order to intersect the wires. For this reason, it is desired to design so that the difference in the number of turns between the first wire and the second wire in contact is changed without requiring a space in the direction along the central axis as much as possible.

Accordingly, the present disclosure provides a coil component including a winding core, a first flange provided at a first end of the winding core in a direction along a central axis, a second flange provided at a second end of the winding core opposite to the first end, a first external electrode and a second external electrode provided on the first flange, a third external electrode and a fourth external electrode provided on the second flange, a first wire wound around the winding core and having a first end connected to the first external electrode and a second end connected to the third external electrode, and a second wire wound around the winding core in a same direction as the first wire. The second wire has a first end connected to the second external electrode and a second end connected to the fourth external electrode, in which regarding the first wire and the second wire, a number of turns increases by one every time one turn is made around the central axis from the first end toward the second end. Also, when a portion directly wound around the winding core is defined as a first layer, and a portion wound from an outside of the first layer in a direction orthogonal to the central axis is defined as a second layer, an m-th turn (where m is an integer equal to or greater than 2) of the first wire includes a portion belonging to the first layer, an (m−1)-th turn of the second wire includes a first portion that belongs to the first layer and is wound adjacent to the m-th turn of the first wire on a side of the second flange in the direction along the central axis, an (m+1)-th turn of the first wire includes a portion that belongs to the first layer and is wound adjacent to the first portion on the side of the second flange in the direction along the central axis, an m-th turn of the second wire includes a portion that belongs to the second layer and is wound from the outside in the direction orthogonal to the central axis on a valley portion between the m-th turn of the first wire and the first portion, and an (m+1)-th turn of the second wire includes a portion that belongs to the second layer and is wound from the outside in the direction orthogonal to the central axis on a valley portion between the first portion and the (m+1)-th turn of the first wire.

Further, the present disclosure is a coil component including a winding core, a first flange provided at a first end of the winding core in a direction along a central axis, a second flange provided at a second end of the winding core opposite to the first end, a first external electrode and a second external electrode provided on the first flange, a third external electrode and a fourth external electrode provided on the second flange, a first wire wound around the winding core and having a first end connected to the first external electrode and a second end connected to the third external electrode, and a second wire wound around the winding core in a same direction as the first wire. The second wire has a first end connected to the second external electrode and a second end connected to the fourth external electrode, in which regarding the first wire and the second wire, a number of turns increases by one every time one turn is made around the central axis from the first end toward the second end. Also, when a portion directly wound around the winding core is defined as a first layer, and a portion wound from an outside of the first layer in a direction orthogonal to the central axis is defined as a second layer, a k-th turn (where k is a positive integer) of the first wire includes a portion belonging to the first layer, a (k+1)-th turn of the first wire includes a portion that belongs to the first layer and is wound adjacent to the k-th turn of the first wire on a side of the second flange in the direction along the central axis, a (k+2)-th turn of the first wire includes a second portion that belongs to the second layer and is wound from the outside in the direction orthogonal to the central axis on a valley portion between the k-th turn of the first wire and the (k+1)-th turn of the first wire, and the second wire includes at least one or more turns wound on a side of the first flange with respect to the second portion in the direction along the central axis, and at least one or more turns wound on the side of the second flange with respect to the second portion in the direction along the central axis.

With the above configuration, the difference in the number of turns between the first wire and the second wire in contact with each other can be changed without requiring a space in the direction along the central axis of the winding core as much as possible.

### BRIEF DESCRIPTION OF THE DRAWINGS

FIG. 1 is a perspective view of a coil component of a first embodiment;

FIG. 2 is a schematic end view illustrating a winding mode of each wire of the coil component of the first embodiment on an end surface orthogonal to an up-down axis;

FIG. 3 is a schematic end view illustrating a winding mode of each wire of the coil component of the first embodiment on an end surface including a central axis and orthogonal to a left-right axis;

FIG. 4 is a schematic end view illustrating a winding mode of each wire of a coil component of a second embodiment on an end surface orthogonal to the up-down axis; and

FIG. 5 is a schematic end view illustrating a winding mode of each wire of the coil component of the second embodiment on an end surface including the central axis and orthogonal to the left-right axis.

### DETAILED DESCRIPTION

Hereinafter, a first embodiment and a second embodiment of a coil component will be described with reference to the drawings. Note that in the drawings, components may be shown in an enlarged manner for easy understanding. In some cases, the dimension ratio of a component differs from an actual dimension ratio or a dimension ratio in another drawing.

### First Embodiment

### <Overall Configuration>

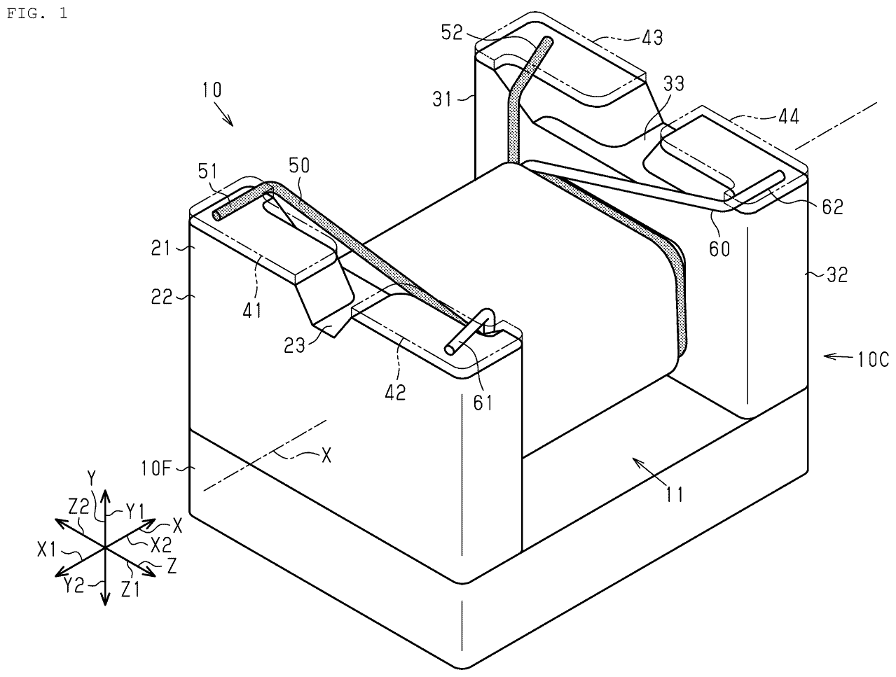

As illustrated in FIG. 1, a coil component 10 includes a drum core 10C and a plate core 10F.

The drum core 10C includes a winding core 11, a first flange 21, and a second flange 31. The winding core 11 has a quadrangular prism shape. The material of the winding core 11 is, for example, Ni—Zn-based ferrite or the like.

The first flange 21 is provided at a first end of the winding core 11 in a direction along a central axis X. Specifically, the first flange 21 is connected to the first end of the winding core 11 in the direction along the central axis X. The second flange 31 is provided at a second end of the winding core 11 in the direction along the central axis X. Specifically, the second flange 31 is connected to the second end of the winding core 11 in the direction along the central axis X. A material of the first flange 21 and the second flange 31 is the same as that of the winding core 11. Further, the first flange 21 and the second flange 31 are integrally molded with the winding core 11.

Here, a specific axis orthogonal to the central axis X is defined as an up-down axis Y. In the first embodiment, the up-down axis Y is a direction orthogonal to the mounting surface when the coil component 10 is mounted on the substrate.

Further, when viewed in the direction along the central axis X, the up-down axis Y is parallel to a short side of the winding core 11. Furthermore, an axis orthogonal to both the central axis X and the up-down axis Y is defined as a left-right axis Z. In the first embodiment, the left-right axis Z is parallel to a long side of the winding core 11 when viewed in the direction along the central axis X. One of directions along the central axis X is defined as a positive direction X1, and a direction opposite to the positive direction X1 is defined as a negative direction X2. In the first embodiment, the positive direction X1 coincides with a direction from the winding core 11 toward the first flange 21. The negative direction X2 coincides with a direction from the winding core 11 toward the second flange 31. Further, one of directions along the up-down axis Y is defined as an upward direction Y1, and a direction opposite to the upward direction Y1 is defined as a downward direction Y2. Furthermore, one of directions along the left-right axis Z is defined as a rightward direction Z1, and a direction opposite to the rightward direction Z1 is defined as a leftward direction Z2. Note that the upward direction Y1 and the downward direction Y2 here are referred to for convenience and do not specify a gravity direction. Furthermore, the rightward direction Z1 and the leftward direction Z2 are also referred to for convenience, and are not intended to limit a left and right direction from a specific viewpoint.

Note that, in the present disclosure, an “upper surface” refers to a surface facing the upward direction Y1 in a direction along the up-down axis Y, and a “lower surface” refers to a surface facing the downward direction Y2. The “upper surface” is not necessarily orthogonal to the upward direction Y1, and for example, when the coil component 10 is viewed from the upward direction Y1 to the downward direction Y2 with respect to the coil component 10, a visible surface is referred to as an “upper surface of the coil component 10”. In this respect, the same applies to the lower surface.

The first flange 21 protrudes outward with respect to the winding core 11 in directions along the up-down axis Y and the left-right axis Z when viewed in the direction along the central axis X. The first flange 21 has a plane-symmetrical shape with respect to a virtual plane including the central axis X and orthogonal to the left-right axis Z.

The first flange 21 includes a main body 22 and a recessed portion 23. The main body 22 has a substantially rectangular parallelepiped shape with a small thickness in the direction along the central axis X. When viewed in the negative direction X2, both edges of the main body 22 in the upward direction Y1 and the downward direction Y2 are parallel to the left-right axis Z. Further, when viewed in the negative direction X2, both edges of the main body 22 in the leftward direction Z2 and the rightward direction Z1 are parallel to the up-down axis Y.

The recessed portion 23 is recessed from the upper surface of the main body 22 toward the downward direction Y2 side. A dimension of the recessed portion 23 in the direction along the left-right axis Z decreases toward the downward direction Y2. The recessed portion 23 is located substantially at a center of the main body 22 in the direction along the left-right axis Z. A dimension of the recessed portion 23 in the direction along the central axis X is the same as a dimension of the main body 22 in the direction along the central axis X. That is, a portion of the first flange 21 on the upward direction Y1 side has a shape bifurcated with the recessed portion 23 interposed therebetween.

The second flange 31 and the first flange 21 have a plane-symmetrical shape with respect to a virtual plane passing through the center of the winding core 11 and orthogonal to the central axis X. That is, the second flange 31 protrudes outward with respect to the winding core 11 in the direction along the up-down axis Y and the direction along the left-right axis Z when viewed from the direction along the central axis X. The second flange 31 includes a main body 32 and a recessed portion 33. The configurations of the main body 32 and the recessed portion 33 of the second flange 31 are similar to those of the main body 22 and the recessed portion 23 of the first flange 21. That is, the recessed portion 33 is recessed from the upper surface of the main body 32 toward the downward direction Y2 side.

The plate core 10F has a rectangular plate shape. A long side of the plate core 10F is parallel to the central axis X. A short side of the plate core 10F is parallel to the left-right axis Z. The plate core 10F is located on the downward direction Y2 side with respect to the drum core 10C. The plate core 10F is connected to both a lower surface of the first flange 21 and a lower surface of the second flange 31. That is, the plate core 10F is bridged between the first flange 21 and the second flange 31. A material of the plate core 10F is the same as a material of the drum core 10C.

The coil component 10 includes a first external electrode 41, a second external electrode 42, a third external electrode 43, and a fourth external electrode 44. The first external electrode 41 is provided on the first flange 21. That is, the first external electrode 41 is attached onto a surface of the first flange 21. The first external electrode 41 is located on a surface of the first flange 21 on the upward direction Y1 side and on the leftward direction Z2 side with respect to the recessed portion 23.

The second external electrode 42 is provided on the first flange 21. That is, the second external electrode 42 is attached onto a surface of the first flange 21. The second external electrode 42 is located on a surface of the first flange 21 on the upward direction Y1 side and on the rightward direction Z1 side with respect to the recessed portion 23.

The third external electrode 43 is provided on the second flange 31. That is, the third external electrode 43 is attached onto a surface of the second flange 31. The third external electrode 43 is located on a surface of the second flange 31 on the upward direction Y1 side and on the leftward direction Z2 side with respect to the recessed portion 33.

The fourth external electrode 44 is provided on the second flange 31. That is, the fourth external electrode 44 is attached onto a surface of the second flange 31. The fourth external electrode 44 is located on a surface of the second flange 31 on the upward direction Y1 side and on the rightward direction Z1 side with respect to the recessed portion 33.

Although not illustrated, these first external electrode 41 to fourth external electrode 44 include a metal layer and a plating layer. The metal layer is, for example, a layer containing silver as a main component. The plating layer includes, for example, a plurality of layers such as a layer containing copper as a main component, a layer containing nickel as a main component, and a layer containing tin as a main component. In the present embodiment, the surfaces of the coil component 10 on which the first external electrode 41 to the fourth external electrode 44 are provided are surfaces facing a substrate when the coil component 10 is mounted on the substrate. Note that, in FIG. 1, the first external electrode 41 to the fourth external electrode 44 are depicted by alternate long and short dash lines.

### <Configurations of First Wire and Second Wire>

As illustrated in FIG. 1, the coil component 10 includes a first wire 50 and a second wire 60. The first wire 50 and the second wire 60 include portions wound around the winding core 11. Note that, in FIG. 1, a winding structure of the portion of the first wire 50 and the second wire 60 wound around the winding core 11 is simplified, and each turn is illustrated as a tubular object integrated in each wire.

Although not illustrated, the first wire 50 includes a conductive wire and an insulating film. The insulating film covers an outer surface of the conductive wire. The first wire 50 has a substantially circular shape in a section orthogonal to a direction in which the first wire 50 extends. The first wire 50 includes a first end 51 and a second end 52 opposite to the first end 51. Note that, in each drawing, the first wire 50 is colored with dots.

As illustrated in FIG. 1, the first end 51 of the first wire 50 is connected to the first external electrode 41. The second end 52 of the first wire 50 is connected to the third external electrode 43. Here, when the first wire 50 is traced from the first end 51 to the second end 52, a portion that first comes into contact with an outer peripheral surface of the winding core 11 is defined as a 1.0 turn portion of the first wire 50. In the first embodiment, the 1.0 turn portion of the first wire 50 is located on a ridgeline on the rightward direction Z1 side and the upward direction Y1 side of the winding core 11.

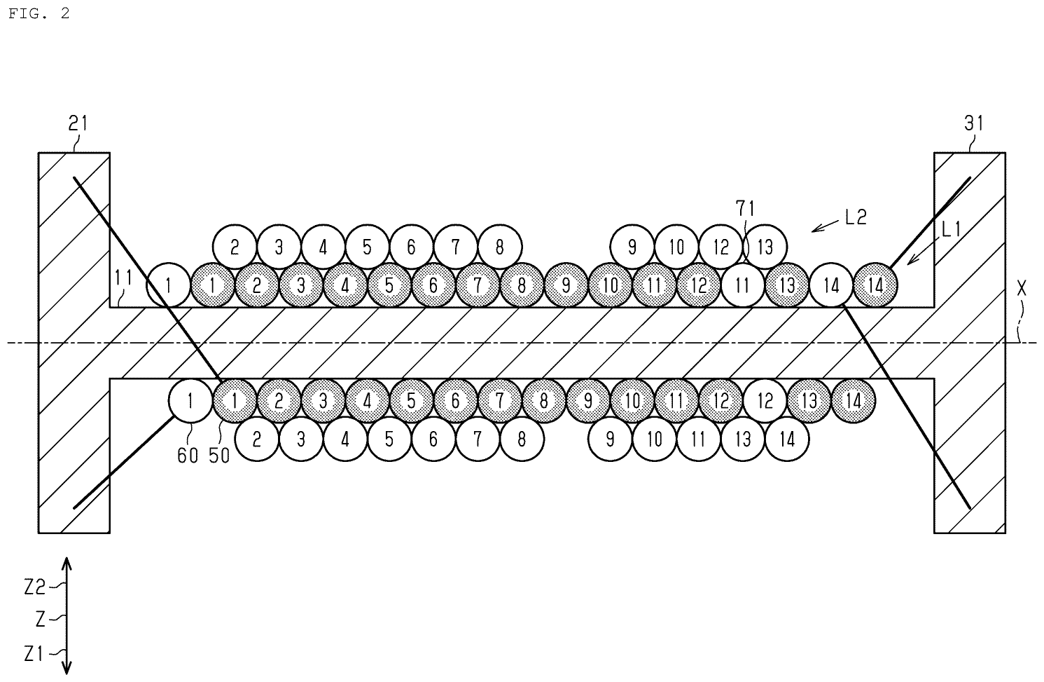

As illustrated in FIG. 2, with respect to the first wire 50, the number of turns of the first wire 50 is increased by 1 every time one turn is made around the central axis X from the first end 51 toward the second end 52. The first wire 50 is wound around the winding core 11 so as to travel clockwise as the number of turns increases when viewed in the negative direction X2. Therefore, for example, when viewed in the negative direction X2, a portion that travels 36 degrees about the central axis X from the 1.0 turn portion of the first wire 50 is a 1.1 turn portion of the first wire 50. Further, the first turn of the first wire 50 indicates a portion of the first wire 50 from a portion of 1.0 turn to immediately before a portion of 2.0 turns. Note that, in FIGS. 2 to 5, any portion of the first turn is indicated as “1” as long as the portion is within the range of the first turn. The same applies to other numbers of turns. Note that the number of turns illustrated in FIG. 2 need not coincide with the number of turns counted from the start of winding in manufacturing.

As illustrated in FIG. 1, the second wire 60 has a configuration similar to that of the first wire 50. That is, the second wire 60 includes a conductive wire and an insulating film. The insulating film covers an outer surface of the conductive wire. The second wire 60 has a substantially circular shape in a section orthogonal to a direction in which the second wire 60 extends. The second wire 60 includes a first end 61 and a second end 62 opposite to the first end 61.

As illustrated in FIG. 1, the first end 61 of the second wire 60 is connected to the second external electrode 42. The second end 62 of the second wire 60 is connected to the fourth external electrode 44. Here, when the second wire 60 is traced from the first end 61 to the second end 62, a portion where an angular position about the central axis X first coincides with an angular position of a 1.0 turn portion of the first wire 50 is defined as a 1.0 turn portion of the second wire 60. That is, in the first embodiment, the 1.0 turn portion of the second wire 60 is located on a straight line connecting a ridge line on the rightward direction Z1 side and the upward direction Y1 side of the winding core 11 and the central axis X when viewed toward the direction along the central axis X.

As illustrated in FIG. 2, with respect to the second wire 60, the number of turns of the second wire 60 is increased by 1 every time one turn is made around the central axis X from the first end 61 toward the second end 62. The second wire 60 is wound around the winding core 11 so as to travel clockwise as the number of turns increases when viewed in the negative direction X2.

Regarding the first wire 50 and the second wire 60, a portion directly wound around the winding core 11 is defined as a first layer L1. Here, “directly wound” includes not only a state where the wire is in contact with the outer peripheral surface of the winding core 11 but also a state where the wire is wound on the winding core 11 without interposing another wire in a state where the wire is floated with respect to the winding core 11.

Further, regarding the first wire 50 and the second wire 60, a portion wound from the outside of the first layer L1 in the direction orthogonal to the central axis X is defined as a second layer L2.

### Winding Mode of Wire of First Embodiment

As illustrated in FIG. 2, the first turn to the 12th turn of the first wire 50 belong to the first layer L1. That is, when m is 12, the m-th turn of the first wire 50 includes a portion belonging to the first layer L1. The first turn to the 12th turn of the first wire 50 are sequentially wound so as to be located closer to the second flange 31 side in the direction along the central axis X as the number of turns increases. Further, each of the first turn to the middle of the 12th turn of the first wire 50 is wound adjacent to each other in the direction along the central axis X. Here, “wound adjacent to each other” is not limited to a case where turns of adjacent wires are in contact with each other. If the turns of the adjacent wires are not in contact with each other, it can be said that the wires are adjacent to each other if no other wire exists on the line segment connecting the central axes of the adjacent wires in a sectional view.

The 13th turn of the first wire 50 belongs to the first layer L1. The 13th turn of the first wire 50 is wound to be separated from the 12th turn of the first wire 50 on the second flange 31 side in the direction along the central axis X. Therefore, the pitch of the spiral of the first wire 50 is larger in a portion from the 12th turn to the 13th turn than in other portions.

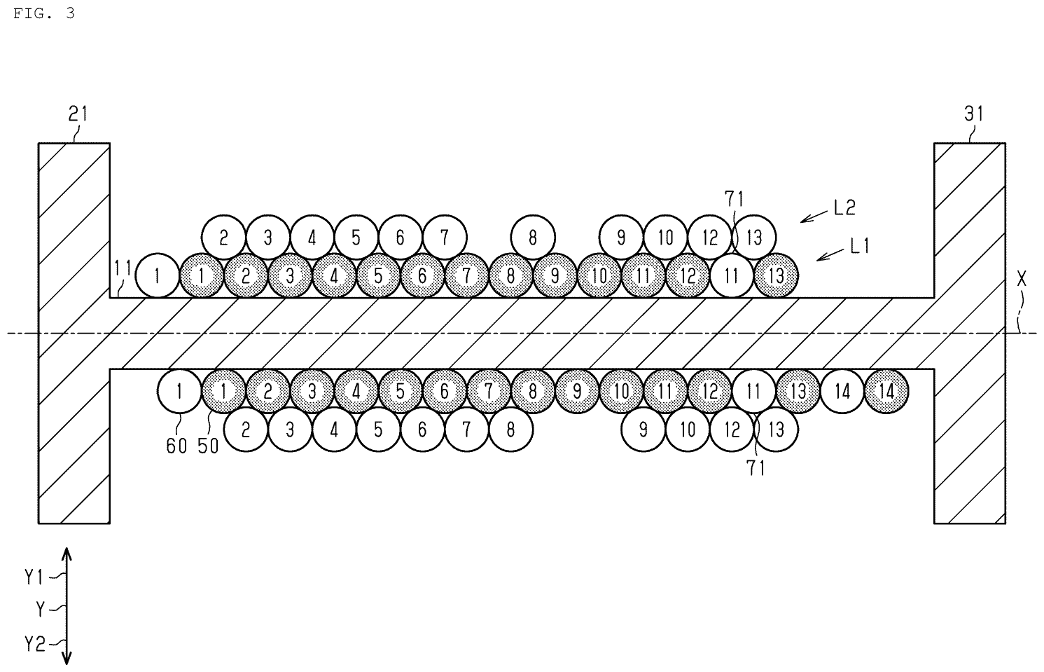

The 14th turn of the first wire 50 belongs to the first layer L1. The 14th turn of the first wire 50 includes a portion wound around the winding core 11 and a portion separated from the winding core 11 and connected to the third external electrode 43. A part of the portion wound around the winding core 11 in the 14th turn of the first wire 50 is wound adjacent to the 13th turn of the first wire 50 on the second flange 31 side in the direction along the central axis X. Specifically, a part of the first wire 50 wound on a surface of the winding core 11 facing the rightward direction Z1 in the 14th turn is wound adjacent to the 13th turn of the first wire 50 on the second flange 31 side in the direction along the central axis X. Further, as illustrated in FIGS. 2 and 3, a part of the first wire 50 wound on the lower surface of the winding core 11 and the surface facing the leftward direction Z2 in the 14th turn is wound to be separated from the 13th turn of the first wire 50 on the second flange 31 side in the direction along the central axis X. As described above, all the portions of the first wire 50 wound around the winding core 11 belong to the first layer L1.

As illustrated in FIG. 2, the first turn of the second wire 60 includes a portion belonging to the first layer L1. The portion is wound adjacent to the first turn of the first wire 50 on the first flange 21 side in the direction along the central axis X. Note that a part of the first turn of the second wire 60 may belong to the second layer L2.

The second turn to the eighth turn of the second wire 60 belong to the second layer L2. The second turn to the eighth turn of the second wire 60 are wound so as to be located closer to the second flange 31 side in the direction along the central axis X as the number of turns increases. Each of the second turn to the middle of the eighth turn of the second wire 60 is wound adjacent to each other in the direction along the central axis X. Further, the second turn of the second wire 60 is wound from the outside in the direction orthogonal to the central axis X on the valley portion between the first turn and the second turn of the first wire 50. That is, the i-th turn (where i is an integer between 2 and 7, inclusive) of the second wire 60 is wound from the outside in the direction orthogonal to the central axis X on the valley portion between the (i−1)-th turn and the i-th turn of the first wire 50.

As illustrated in FIG. 3, a part of the eighth turn of the second wire 60 is wound to be separated from the seventh turn of the second wire 60 on the second flange 31 side in the direction along the central axis X. Therefore, the pitch of the spiral of the second wire 60 is larger in the portion from the eighth turn to the ninth turn than in other portions. Note that the portion of the first wire 50 from the eighth turn to the ninth turn may not be wound on the valley portion formed by the first layer L1.

The ninth turn and the 10th turn of the second wire 60 belong to the second layer L2. The ninth turn and the 10th turn of the second wire 60 are wound so as to be located closer to the second flange 31 side in the direction along the central axis X as the number of turns increases. The ninth turn and the 10th turn of the second wire 60 are wound adjacent to each other in the direction along the central axis X. Further, the ninth turn of the second wire 60 is wound from the outside in the direction orthogonal to the central axis X on the valley portion between the ninth turn and the 10th turn of the first wire 50. That is, the j-th turn (where j is an integer between 9 and 10, inclusive) of the second wire 60 is wound from the outside in the direction orthogonal to the central axis X on the valley portion between the (j+1)-th turn and the (j+2)-th turn of the first wire 50.

As illustrated in FIG. 2, the 11th turn of the second wire 60 includes a portion belonging to the second layer L2. In the first embodiment, the portion is a portion including a portion wound on a surface facing the rightward direction Z1 of the winding core 11 of the 11th turn of the second wire 60. The portion is wound adjacent to the 10th turn of the second wire 60 on the second flange 31 side in the direction along the central axis X.

Further, as illustrated in FIGS. 2 and 3, the 11th turn of the second wire 60 includes a first portion 71 belonging to the first layer L1. In the first embodiment, the first portion 71 is a portion including a portion wound on a lower surface, a surface facing the leftward direction Z2, and an upper surface of the winding core 11 in the 11th turn of the second wire 60. The first portion 71 is wound adjacent to the 12th turn of the first wire 50 on the second flange 31 side in the direction along the central axis X. That is, when m is 12, the (m−1)-th turn of the second wire 60 includes the first portion 71 that belongs to the first layer L1 and is wound adjacent to the m-th turn of the first wire 50 on the second flange 31 side in the direction along the central axis X. A part of the first wire 50 from the 10th turn to the 11th turn intersects with a part of the first wire 50 belonging to the first layer L1 from the 12th turn to the 13th turn. Accordingly, the first portion 71 may locally ride on the first layer L1. Note that, in the present disclosure, the entire first portion 71 may be regarded as belonging to the first layer L1 because the riding on is local.

Further, the first portion 71 is wound adjacent to the 13th turn of the first wire 50 on the first flange 21 side in the direction along the central axis X. That is, when m is 12, the (m+1)-th turn of the first wire 50 includes a portion that belongs to the first layer L1 and is wound adjacent to the first portion 71 on the second flange 31 side in the direction along the central axis X.

As illustrated in FIG. 2, the 12th turn of the second wire 60 includes a portion belonging to the first layer L1. Specifically, the portion is a portion including a portion wound on the surface of the winding core 11 facing the rightward direction Z1 in the 12th turn of the second wire 60. The portion is wound adjacent to the 12th turn of the first wire 50 on the second flange 31 side in the direction along the central axis X. Further, the portion is wound adjacent to the 13th turn of the first wire 50 on the first flange 21 side in the direction along the central axis X.

Further, as illustrated in FIGS. 2 and 3, the 12th turn of the second wire 60 includes a portion belonging to the second layer L2. Specifically, the portion is a portion including a portion wound on the lower surface, the surface facing the leftward direction Z2, and the upper surface of the winding core 11 in the 12th turn of the second wire 60. The portion is wound adjacent to the 10th turn of the second wire 60 on the second flange 31 side in the direction along the central axis X. Further, the portion is wound from the outside in the direction orthogonal to the central axis X on the valley portion between the 12th turn of the first wire 50 and the first portion 71. That is, when m is 12, the m-th turn of the second wire 60 includes a portion that belongs to the second layer L2 and is wound from the outside in the direction orthogonal to the central axis X on the valley portion between the m-th turn of the first wire 50 and the first portion 71.

As illustrated in FIG. 2, the 13th turn of the second wire 60 includes a portion belonging to the second layer L2. A part of the 13th turn of the second wire 60 is wound adjacent to the 11th turn of the second wire 60 on the second flange 31 side in the direction along the central axis X. The part is a portion including a portion wound on the surface of the winding core 11 facing the rightward direction Z1 in the 13th turn of the second wire 60. The part is wound from the outside in the direction orthogonal to the central axis X on the valley portion between the 12th turn of the first wire 50 and the 12th turn of the second wire 60.

As illustrated in FIGS. 2 and 3, a remaining part of the 13th turn of the second wire 60 is wound adjacent to the 12th turn of the second wire 60 on the second flange 31 side in the direction along the central axis X. The part is a portion including a portion wound on the lower surface, the surface facing the leftward direction Z2, and the upper surface of the winding core 11 in the 13th turn of the second wire 60. The part is wound from the outside in the direction orthogonal to the central axis X on the valley portion between the first portion 71 and the 13th turn of the first wire 50. That is, when m is 12, the (m+1)-th turn of the second wire 60 belongs to the second layer L2 and includes a portion wound from the outside in the direction orthogonal to the central axis X on the valley portion between the first portion 71 and the (m+1)-th turn of the first wire 50.

As illustrated in FIG. 2, the 14th turn of the second wire 60 includes a portion belonging to the second layer L2. Specifically, the portion is a portion including a portion wound on the surface of the winding core 11 facing the rightward direction Z1 in the 14th turn of the second wire 60. The portion is wound adjacent to the 13th turn of the second wire 60 on the second flange 31 side in the direction along the central axis X. Further, the portion is wound from the outside in the direction orthogonal to the central axis X on the valley portion between the 12th turn of the second wire 60 and the 13th turn of the first wire 50.

Further, as illustrated in FIGS. 2 and 3, the 14th turn of the second wire 60 includes a portion belonging to the first layer L1. Specifically, the portion is a portion including a portion wound on the lower surface of the winding core 11 and the surface facing the leftward direction Z2 in the 14th turn of the second wire 60. The portion is wound adjacent to the 13th turn of the first wire 50 on the second flange 31 side in the direction along the central axis X. Further, the portion is wound adjacent to the 14th turn of the first wire 50 on the first flange 21 side in the direction along the central axis X. Further, the 14th turn of the second wire 60 includes a portion separated from the winding core 11 and connected to the fourth external electrode 44.

### Effects of First Embodiment

(1-1) In the first embodiment, when m is 12, the (m−1)-th turn of the second wire 60 includes the first portion 71. Further, the m-th turn and the (m+1)-th turn of the second wire 60 each include a portion wound on the first portion 71 from the outside in the direction orthogonal to the central axis X. That is, three turns from the (m−1)-th turn to the (m+1)-th turn of the second wire 60 are wound in a small space in the direction along the central axis X. On the other hand, the m-th turn of the first wire 50 includes a portion wound adjacent to the first portion 71 on the first flange 21 side in the direction along the central axis X. Further, the (m+1)-th turn of the first wire 50 includes a portion wound adjacent to the first portion 71 on the second flange 31 side in the direction along the central axis X. In other words, the first wire 50 is wound across the first portion 71. In this manner, the first wire 50 straddles the portion wound by three turns in a small space. Accordingly, the difference in the number of turns between the first wire 50 and the second wire 60 in contact with each other is changed before and after the first portion 71.

Specifically, as illustrated in FIG. 3, in the first embodiment, the 10th turn of the second wire 60 includes a portion in contact with the 11th turn and the 12th turn of the first wire 50. On the other hand, the 14th turn of the second wire 60 includes a portion in contact with the 13th turn and the 14th turn of the first wire 50. As described above, the portion where the number of turns is smaller than that of the first portion 71 includes a portion where the (j+1)-th turn and the (j+2)-th turn of the first wire 50 are in contact with the j-th turn of the second wire 60. Further, the (p−1)-th turn and the p-th turn of the first wire 50 are in contact with the p-th turn of the second wire 60 at a portion where the number of turns is larger than that of the first portion 71. In this manner, the difference in the number of turns between the first wire 50 and the second wire 60 in contact before and after the first portion 71 is changed.

In the first embodiment, since the second wire 60 includes the first portion 71, the space for winding the second wire 60 in the direction along the central axis X is reduced as compared with the configuration in which the second wire 60 belongs to the second layer L2 as a whole. Thus, with the above configuration, it is possible to change the difference in the number of turns between the first wire 50 and the second wire 60 in contact with each other while reducing the space in the direction along the central axis X on which the second wire 60 is wound.

(1-2) In the first embodiment, all the portions of the first wire 50 wound around the winding core 11 belong to the first layer L1. That is, the winding mode of the first wire 50 in the first embodiment is simple as compared with the mode in which the first wire 50 is wound in both the first layer L1 and the second layer L2. With such a configuration, it is possible to suppress winding disturbance when winding the first wire 50.

### Second Embodiment

Hereinbelow, a second embodiment of a coil component will be described. Note that, in the coil component of the second embodiment, the basic configurations of the drum core 10C, the plate core 10F, and the first wire 50, the basic configuration of the second wire 60, and the configurations of the first external electrode 41 to the fourth external electrode 44 are similar to those of the first embodiment. Hereinafter, a winding mode of the first wire 50 and the second wire 60 having a configuration different from that of the first embodiment will be described.

### Winding Mode of Wire of Second Embodiment

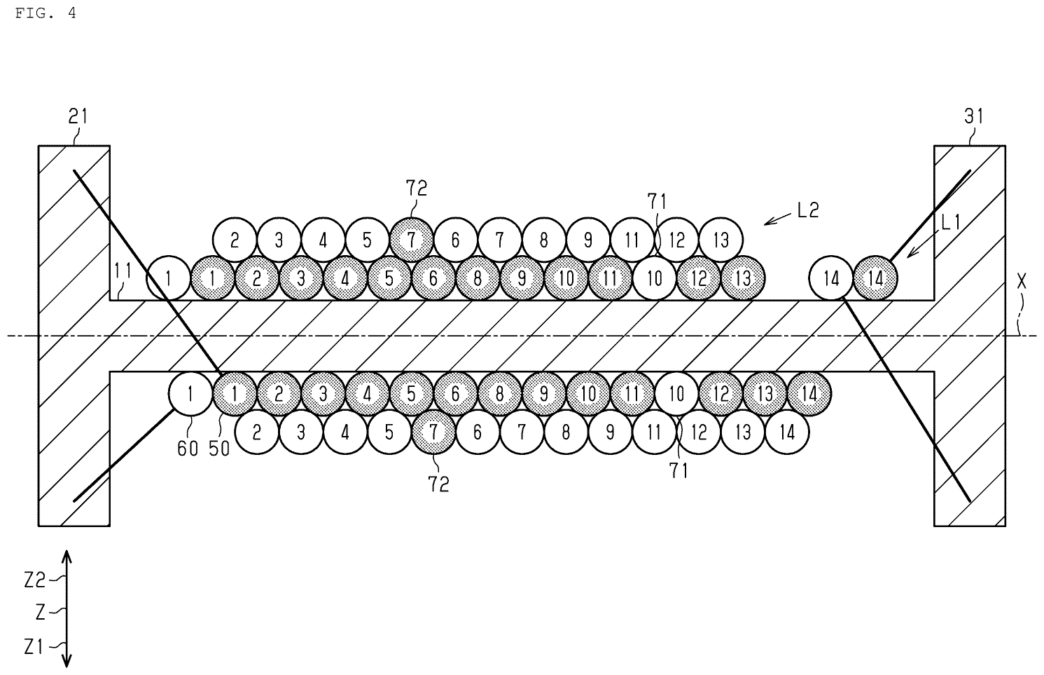

As illustrated in FIG. 4, the first turn to the sixth turn of the first wire 50 belong to the first layer L1. In addition, the first turn to the sixth turn of the first wire 50 are sequentially wound so as to be located closer to the second flange 31 side in the direction along the central axis X as the number of turns increases. Each of the first turn to the middle of the sixth turn of the first wire 50 is wound adjacent to each other in the direction along the central axis X. That is, when n is 5, the n-th turn and the (n+1)-th turn of the first wire 50 include a portion belonging to the first layer L1.

The seventh turn of the first wire 50 includes a second portion 72 belonging to the second layer L2. Specifically, the second portion 72 is wound from the outside in the direction orthogonal to the central axis X on the valley portion between the fifth turn and the sixth turn of the first wire 50. Thus, when n is 5, the (n+2)-th turn of the first wire 50 belongs to the second layer L2, and includes the second portion 72 wound from the outside in the direction orthogonal to the central axis X on the valley portion between the n-th turn of the first wire 50 and the (n+1)-th turn of the first wire 50. Note that the portion of the second portion 72 that rides on the second layer L2 need not be exactly the portion of 7.0 turns.

For example, the portion of the second portion 72 that rides on may be after 7.0 turns. In this case, a part of the seventh turn of the first wire 50 including the portion of 7.0 turns may belong to the first layer L1. In addition, a part of the 11th turn including 8.0 turns of the first wire 50 may belong to the second layer L2 continuously with the second portion 72. In this case, a part of the eighth turn of the first wire 50 may belong to the second layer L2. In addition, a part of the first wire 50 before 7.0 turns may belong to the second layer L2 continuously with the second portion 72. In this case, a part of the sixth turn of the first wire 50 may belong to the second layer L2.

The eighth turn to the 11th turn of the first wire 50 belong to the first layer L1. Further, the eighth turn to the 11th turn of the first wire 50 are sequentially wound so as to be located closer to the second flange 31 side in the direction along the central axis X as the number of turns increases. Each of the eighth turn to the middle of the 11th turn of the first wire 50 is wound adjacent to each other in the direction along the central axis X. That is, when n is 5 and m is 11, the (n+3)-th turn to the m-th turn of the first wire 50 belong to the first layer L1, and are sequentially wound so as to be located closer to the second flange 31 side in the direction along the central axis X as the number of turns increases.

A 12th turn of the first wire 50 belongs to the first layer L1. The 12th turn of the first wire 50 is wound to be separated from the 11th turn of the first wire 50 on the second flange 31 side in the direction along the central axis X. Therefore, the pitch of the spiral of the first wire 50 is larger in a portion from the 11th turn to the 12th turn than in other portions.

The 13th turn of the first wire 50 belongs to the first layer L1. The 13th turn of the first wire 50 is wound adjacent to the 12th turn of the first wire 50 on the second flange 31 side in the direction along the central axis X.

The 14th turn of the first wire 50 belongs to the first layer L1. The 14th turn of the first wire 50 includes a portion wound around the winding core 11 and a portion separated from the winding core 11 and connected to the third external electrode 43. A part of the 14th turn of the first wire 50 wound around the winding core 11 is wound adjacent to the 13th turn of the first wire 50 on the second flange 31 side in the direction along the central axis X. Specifically, a part of the first wire 50 wound on a surface of the winding core 11 facing the rightward direction Z1 in the 14th turn is wound adjacent to the 13th turn of the first wire 50 on the second flange 31 side in the direction along the central axis X.

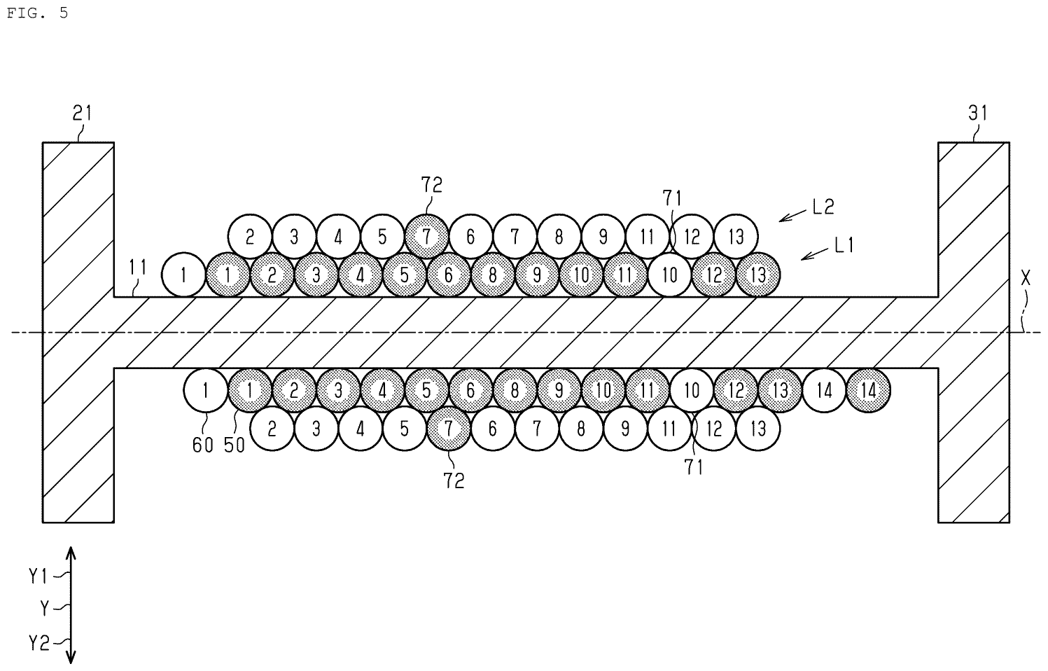

Further, a remaining part of the 14th turn of the first wire 50 is wound to be separated from the 13th turn of the first wire 50 on the second flange 31 side in the direction along the central axis X. Specifically, as illustrated in FIGS. 4 and 5, a part of the first wire 50 wound on the lower surface of the winding core 11 and the surface facing the leftward direction Z2 in the 14th turn is wound adjacent to the 13th turn of the first wire 50 on the second flange 31 side in the direction along the central axis X.

As illustrated in FIG. 4, the first turn of the second wire 60 includes a portion belonging to the first layer L1. The portion is wound adjacent to the first turn of the first wire 50 on the first flange 21 side in the direction along the central axis X. Note that a part of the first turn of the second wire 60 may belong to the second layer L2.

The second turn to the fourth turn of the second wire 60 belong to the second layer L2. The second turn to the fourth turn of the second wire 60 are wound so as to be located closer to the second flange 31 side in the direction along the central axis X as the number of turns increases. Each of the second turn to the fourth turn of the second wire 60 is wound adjacent to each other in the direction along the central axis X. Further, the second turn of the second wire 60 is wound from the outside in the direction orthogonal to the central axis X on the valley portion between the first turn and the second turn of the first wire 50. That is, the i-th turn (where i is an integer between 2 and 4, inclusive) of the second wire 60 is wound from the outside in the direction orthogonal to the central axis X on the valley portion between the (i−1)-th turn and the i-th turn of the first wire 50.

The fifth turn of the second wire 60 belongs to the second layer L2. The fifth turn of the second wire 60 includes a portion wound adjacent to the fourth turn of the second wire 60 on the second flange 31 side in the direction along the central axis X. The portion is wound adjacent to the seventh turn of the first wire 50 on the first flange 21 side in the direction along the central axis X. In other words, the fifth turn of the second wire 60 includes a portion wound on the first flange 21 side with respect to the second portion 72 in the direction along the central axis X. Therefore, the second wire 60 includes at least one or more turns wound on the first flange 21 side with respect to the second portion 72 in the direction along the central axis X.

In the fifth turn of the second wire 60, the portion wound adjacent to the second portion 72 is wound from the outside in the direction orthogonal to the central axis X on the valley portion between the fourth turn and the fifth turn of the first wire 50. That is, the portion is wound on the first flange 21 side with respect to the fifth turn of the first wire 50 in the direction along the central axis X. In other words, when n is 5, the n-th turn of the second wire 60 includes a portion wound on the first flange 21 side with respect to the n-th turn of the first wire 50 in the direction along the central axis X. Note that “the n-th turn of the second wire 60 is wound on the first flange 21 side with respect to the n-th turn of the first wire 50 in the direction along the central axis X” means that the center of the n-th turn of the second wire 60 is located on the first flange 21 side with respect to the center of the n-th turn of the first wire 50 in the direction along the central axis X when each wire is viewed from the end surface as illustrated in FIG. 5. Note that, in some cases, a portion of the second wire 60 from the fifth turn to the sixth turn rides over a portion of the first wire 50 from the sixth turn to the seventh turn and is located outside the second layer L2 in the direction orthogonal to the central axis X. That is, one portion of the second wire 60 from the fifth turn to the sixth turn intersects the second portion 72. Accordingly, a part of the second wire 60 from the fifth turn to the sixth turn may locally ride on the outside in the direction orthogonal to the central axis X with respect to the second layer L2. Note that, in the present disclosure, the fifth turn to the sixth turn of the second wire 60 may be regarded as belonging to the second layer L2 as a whole because the riding on is local.

The sixth turn of the second wire 60 belongs to the second layer L2. The sixth turn of the second wire 60 includes a portion wound adjacent to the seventh turn of the first wire 50 on the second flange 31 side in the direction along the central axis X. Specifically, the sixth turn of the second wire 60 includes a portion wound on the second flange 31 side with respect to the second portion 72 in the direction along the central axis X. As described above, the second wire 60 includes at least one or more turns wound on the second flange 31 side with respect to the second portion 72 in the direction along the central axis X.

In the sixth turn of the second wire 60, the portion wound adjacent to the second portion 72 is wound from the outside in the direction orthogonal to the central axis X on the valley portion between the sixth turn and the eighth turn of the first wire 50. That is, the portion is wound on the second flange 31 side with respect to the sixth turn of the first wire 50 in the direction along the central axis X. In other words, when n is 5, the (n+1)-th turn of the second wire 60 includes a portion wound on the second flange 31 side with respect to the (n+1)-th turn of the first wire 50 in the direction along the central axis X.

The seventh turn to the middle of the ninth turn of the second wire 60 belong to the second layer L2. The seventh turn to the ninth turn of the second wire 60 are wound so as to be located closer to the second flange 31 side in the direction along the central axis X as the number of turns increases. Each of the seventh turn to the middle of the ninth turn of the second wire 60 is wound adjacent to each other in the direction along the central axis X. Further, the seventh turn of the second wire 60 is wound from the outside in the direction orthogonal to the central axis X on the valley portion between the eighth turn and the ninth turn of the first wire 50. That is, the j-th turn (where j is an integer between 7 and 9, inclusive) of the second wire 60 is wound from the outside in the direction orthogonal to the central axis X on the valley portion between the (j+1)-th turn and the (j+2)-th turn of the first wire 50. Note that a part of the ninth turn of the second wire 60 may belong to the first layer L1. Further, when n is 5 and m is 11, the (n+1)-th turn to the middle of the (m−2)-th turn of the second wire 60 belong to the second layer L2, and are sequentially wound so as to be located closer to the second flange 31 side in the direction along the central axis X as the number of turns increases.

As illustrated in FIGS. 4 and 5, the 10th turn of the second wire 60 includes a first portion 71 belonging to the first layer L1. The first portion 71 is wound adjacent to the 11th turn of the first wire 50 on the second flange 31 side in the direction along the central axis X. That is, when m is 11, the (m−1)-th turn of the second wire 60 belongs to the first layer L1, and is wound adjacent to the m-th turn of the first wire 50 on the second flange 31 side in the direction along the central axis X.

Further, the first portion 71 is wound adjacent to the 12th turn of the first wire 50 on the first flange 21 side in the direction along the central axis X. That is, when m is 11, the (m+1)-th turn of the first wire 50 belongs to the first layer L1 and includes a portion wound adjacent to the first portion 71 on the second flange 31 side in the direction along the central axis X. Note that a part of the 10th turn of the second wire 60 may belong to the second layer L2.

The 11th turn of the second wire 60 includes a portion belonging to the second layer L2. The portion is wound adjacent to the ninth turn of the second wire 60 on the second flange 31 side in the direction along the central axis X. Further, the portion is wound from the outside in the direction orthogonal to the central axis X on the valley portion between the 11th turn of the first wire 50 and the first portion 71. That is, when m is 11, the m-th turn of the second wire 60 belongs to the second layer L2 and includes a portion wound from the outside in the direction orthogonal to the central axis X on the valley portion between the m-th turn of the first wire 50 and the first portion 71.

As illustrated in FIG. 4, the 12th turn of the second wire 60 belongs to the second layer L2. The 12th turn of the second wire 60 is wound adjacent to the 11th turn of the second wire 60 on the second flange 31 side in the direction along the central axis X. The 12th turn of the second wire 60 is wound from the outside in the direction orthogonal to the central axis X on the valley portion between the first portion 71 and the 12th turn of the first wire 50. That is, when m is 11, the (m+1)-th turn of the second wire 60 belongs to the second layer L2 and includes a portion wound from the outside in the direction orthogonal to the central axis X on the valley portion between the first portion 71 and the (m+1)-th turn of the first wire 50.

The 13th turn of the second wire 60 belongs to the second layer L2. The 13th turn of the second wire 60 is wound adjacent to the 12th turn of the second wire 60 on the second flange 31 side in the direction along the central axis X. The 13th turn of the second wire 60 is wound from the outside in the direction orthogonal to the central axis X on the 12th turn and the 13th turn of the first wire 50.

As illustrated in FIG. 4, the 14th turn of the second wire 60 includes a portion belonging to the second layer L2. Specifically, the portion is a portion including a portion wound on the surface of the winding core 11 facing the rightward direction Z1 in the 14th turn of the second wire 60. The portion is wound adjacent to the 13th turn of the second wire 60 on the second flange 31 side in the direction along the central axis X. Further, the portion is wound from the outside in the direction orthogonal to the central axis X on the valley portion between the 13th turn and the 14th turn of the first wire 50.

Further, as illustrated in FIGS. 4 and 5, the 14th turn of the second wire 60 includes a portion belonging to the first layer L1. Specifically, the portion is a portion including a portion wound on the lower surface of the winding core 11 and the surface facing the leftward direction Z2 in the 14th turn of the second wire 60. The portion is wound adjacent to the 13th turn of the first wire 50 on the second flange 31 side in the direction along the central axis X. Further, the portion is wound adjacent to the 14th turn of the first wire 50 on the first flange 21 side in the direction along the central axis X. Further, the 14th turn of the second wire 60 includes a portion separated from the winding core 11 and connected to the fourth external electrode 44.

### Effects of Second Embodiment

In the second embodiment, in addition to an effect similar to the effect (1-1) of the first embodiment, the following effects can be further obtained.

(2-1) In the second embodiment, when n is 5, the (n+2)-th turn of the first wire 50 includes the second portion 72 wound from the outside in the direction orthogonal to the central axis X on the valley portion between the n-th turn and the (n+1)-th turn of the first wire 50. These three turns from the n-th turn to the (n+2)-th turn are wound in a small space in the direction along the central axis X. On the other hand, the second wire 60 includes at least one or more turns wound on the first flange 21 side with respect to the second portion 72 in the direction along the central axis X. Further, the second wire 60 includes at least one or more turns wound on the second flange 31 side with respect to the second portion 72 in the direction along the central axis X. In other words, the second wire 60 is wound across the second portion 72. As described above, the second wire 60 straddles the second portion 72, so that the second wire also straddles the portion wound by 3 turns in a small space. Accordingly, the difference in the number of turns between the first wire 50 and the second wire 60 in contact before and after the second portion 72 is changed.

Specifically, in the second embodiment, as illustrated in FIG. 5, the fourth turn of the second wire 60 includes a portion in contact with the third turn and the fourth turn of the first wire 50. On the other hand, the seventh turn of the second wire 60 includes a portion in contact with the eighth turn and the ninth turn of the first wire 50. As described above, the portion where the number of turns is smaller than that of the second portion 72 includes a portion where the (i−1)-th turn and the i-th turn of the first wire 50 are in contact with the i-th turn of the second wire 60. Further, the portion where the number of turns is larger than that of the second portion 72 includes a portion where the (j+1)-th turn and the (j+2)-th turn of the first wire 50 are in contact with the j-th turn of the second wire 60. That is, the difference in the number of turns between the first wire 50 and the second wire 60 in contact before and after the second portion 72 is changed.

In the first embodiment, since the first wire 50 includes the second portion 72, the space for winding the second wire 60 in the direction along the central axis X is reduced as compared with the configuration in which the first wire 50 belongs to the first layer L1 as a whole. Therefore, with the above configuration, it is possible to change the difference in the number of turns between the first wire 50 and the second wire 60 in contact with each other while further reducing the space in the direction along the central axis X on which the first wire 50 is wound.

(2-2) In the second embodiment, the n-th turn of the second wire 60 includes a portion wound on the first flange 21 side with respect to the n-th turn of the first wire 50 in the direction along the central axis X. Further, the (n+1)-th turn of the second wire 60 includes a portion wound on the second flange 31 side with respect to the (n+1)-th turn of the first wire 50 in the direction along the central axis X. That is, when the anteroposterior relationship of the same turn of each wire is compared, the anteroposterior relationship is reversed from the n-th turn to the (n+1)-th turn. When the anteroposterior relationship of the wire occurs, the positive and negative of the stray capacitance may be changed before the n-th turn and after the (n+1)-th turn.

(2-3) In the second embodiment, the (n+3)-th turn to the m-th turn of the first wire 50 belong to the first layer L1, and are sequentially wound so as to be located closer to the second flange 31 side in the direction along the central axis X as the number of turns increases. Further, in the second embodiment, the (n+1)-th turn to the middle of the (m−2)-th turn of the second wire 60 belong to the second layer L2, and are sequentially wound so as to be located closer to the second flange 31 side in the direction along the central axis X as the number of turns increases. That is, in the first wire 50, the turn next to the second portion 72 to the turn adjacent to the first portion 71 of the second wire 60 belong to the first layer L1. Further, in the second wire 60, the turn adjacent to the second portion 72 to the middle of the turn in front of the first portion 71 belong to the second layer L2. That is, in the range of the turn, the vertical relationship between the first layer L1 and the second layer L2 in the first wire 50 and the second wire 60 is not switched. With this configuration, the winding disturbance is less likely to occur within the range of the turn, and it is possible to prevent the positional relationship of each wire from being unintentionally changed.

### Modifications

The first embodiment, the second embodiment, and modifications below can be implemented in combination within a range that is not technically contradictory.

In the first embodiment and the second embodiment, the configuration of the coil component 10 is not limited to the above configuration. For example, the coil component 10 need not include the plate core 10F. Further, the shape of the plate core 10F is not limited to a rectangular plate shape. For example, the plate core 10F may have an elliptical plate shape or the like.

In the first embodiment and the second embodiment, the shape of the winding core 11 is not limited to the example of the above embodiment. For example, the shape of the winding core 11 may be a columnar shape or a polygonal columnar shape other than a quadrangular columnar shape.

In the first embodiment and the second embodiment, the materials of the drum core 10C and the plate core 10F are not limited to the examples of the above embodiment. For example, the materials of the drum core 10C and the plate core 10F are not limited to Ni—Zn-based ferrite, and may be Mn—Zn-based ferrite or the like. In addition, the materials of the drum core 10C and the plate core 10F may be ferrite, alumina, a synthetic resin, a mixture thereof, or the like.

In the first embodiment and the second embodiment, the configuration of the drum core 10C is not limited to the example of the above embodiment. For example, the first flange 21 need not include the recessed portion 23. In this case, for example, it is sufficient if the first external electrode 41 and the second external electrode 42 are separated from each other. The same applies to the second flange 31.

In the first embodiment and the second embodiment, the materials and shapes of the first external electrode 41 to the fourth external electrode 44 are not limited to the examples of the respective embodiments. For example, the plating layers of the first external electrode 41 to the fourth external electrode 44 may be one layer having conductivity. In addition, the first external electrode 41 to the fourth external electrode 44 may include no plating layer, and a conductive metal layer may be exposed. Further, for example, the first external electrode 41 to the fourth external electrode 44 may be formed by a plate-shaped metal material.

In the first embodiment and the second embodiment, the sectional shapes of the first wire 50 and the second wire 60 are not limited to the example of the above embodiment. For example, the sectional shape of the first wire 50 and the second wire 60 may be an elliptical shape, a rectangular shape, or the like.

In the first embodiment and the second embodiment, the total number of turns of the first wire 50 is not limited to the example of the above embodiment. The same applies to the total number of turns of the second wire 60. In addition, the total number of turns of the first wire 50 and the total number of turns of the second wire 60 may be different from each other.

In the first embodiment and the second embodiment, the turns belonging to the first layer L1 and the number of turns are not limited as long as the m-th turn of the first wire 50, the (m+1)-th turn of the first wire 50, and the (m−1)-th turn of the second wire 60 belong to the first layer L1. Further, as long as the m-th turn and the (m+1)-th turn of the second wire 60 belong to the second layer L2, the turns belonging to the second layer L2 and the number of turns are not limited.

In the first embodiment and the second embodiment, the first portion 71 of the second wire 60 only needs to be wound adjacent to the m-th turn of the first wire 50 on the second flange 31 side in the direction along the central axis X. Further, the (m+1)-th turn of the first wire 50 only needs to include a portion wound adjacent to the first portion 71 on the second flange 31 side in the direction along the central axis X. As long as the above condition is satisfied, the arrangement in the direction along the central axis X of each turn of each wire in the first layer L1 is not limited to the example of the above embodiment.

In the first embodiment and the second embodiment, the m-th turn of the second wire 60 only needs to include a portion wound from the outside in the direction orthogonal to the central axis X on the valley portion between the m-th turn of the first wire 50 and the first portion 71. Further, the (m+1)-th turn of the second wire 60 only needs to include a portion wound from the outside in the direction orthogonal to the central axis X on the valley portion between the first portion 71 and the (m+1)-th turn of the first wire 50. As long as the above condition is satisfied, the arrangement of the second layer L2 in the direction along the central axis X of each turn of each wire is not limited to the example of the above embodiment.

In the first embodiment, a part of the portion of the first wire 50 wound around the winding core 11 may be located in the second layer L2 or outside the second layer L2 in the direction orthogonal to the central axis X.

In the first embodiment, the first portion 71 of the second wire 60 is not limited to the 11th turn of the second wire 60. When m is an integer equal to or greater than 2, the (m−1)-th turn of the second wire 60 only needs to include the first portion 71. The same applies to the second embodiment.

In the second embodiment, the (n+2)-th turn of the second wire 60 need not include the second portion 72. That is, the entire portion of the second wire 60 wound around the winding core 11 may belong to the first layer L1.

In the second embodiment, the second portion 72 of the first wire 50 is not limited to the seventh turn. When m is an integer equal to or greater than 4 and n is an integer equal to or less than m−3, the (n+2)-th turn of the first wire 50 only needs to include the second portion 72.

In the second embodiment, the n-th turn of the second wire 60 may be wound on the first flange 21 side with respect to the n-th turn of the first wire 50 in the direction along the central axis X, and the (n+1)-th turn of the second wire 60 may include a portion wound on the first flange 21 side with respect to the (n+1)-th turn of the first wire 50 in the direction along the central axis X. In addition, the n-th turn of the second wire 60 may be wound on the second flange 31 side with respect to the n-th turn of the first wire 50 in the direction along the central axis X, and the (n+1)-th turn of the second wire 60 may include a portion wound on the second flange 31 side with respect to the (n+1)-th turn of the first wire 50 in the direction along the central axis X.

In the second embodiment, from the viewpoint of changing the difference in the number of turns between the first wire 50 and the second wire 60 in contact with each other without requiring a space in the direction along the central axis X as much as possible, the second wire 60 does not necessarily include the first portion 71. That is, the first wire 50 only needs to include the second portion 72. In this case, the k-th turn (where k is a positive integer) of the first wire 50 only needs to belong to the first layer L1. Further, in this case, the (k+1)-th turn of the first wire 50 only needs to include a portion that belongs to the first layer L1 and is wound adjacent to the k-th turn of the first wire 50 on the second flange 31 side in the direction along the central axis X. Furthermore, in this case, the (k+2)-th turn of the first wire 50 only needs to include the second portion 72 that belongs to the second layer L2 and is wound from the outside in the direction orthogonal to the central axis X on the valley portion between the k-th turn of the first wire 50 and the (k+1)-th turn of the first wire 50. Further, in this case, the second wire 60 only needs to include at least one or more turns wound on the first flange 21 side with respect to the second portion 72 in the direction along the central axis X, and at least one or more turns wound on the second flange 31 side with respect to the second portion 72 in the direction along the central axis X.

### <Supplementary Note>

A technical idea that can be grasped from the above embodiment and modifications will be described.

[1] A coil component including a winding core, a first flange provided at a first end of the winding core in a direction along a central axis, a second flange provided at a second end of the winding core opposite to the first end, a first external electrode and a second external electrode provided on the first flange, a third external electrode and a fourth external electrode provided on the second flange, a first wire wound around the winding core and having a first end connected to the first external electrode and a second end connected to the third external electrode, and a second wire wound around the winding core in a same direction as the first wire. The second wire has a first end connected to the second external electrode and a second end connected to the fourth external electrode, in which regarding the first wire and the second wire, a number of turns increases by one every time one turn is made around the central axis from the first end toward the second end. Also, when a portion directly wound around the winding core is defined as a first layer, and a portion wound from an outside of the first layer in a direction orthogonal to the central axis is defined as a second layer, an m-th turn (where m is an integer equal to or greater than 2) of the first wire includes a portion belonging to the first layer, an (m−1)-th turn of the second wire includes a first portion that belongs to the first layer and is wound adjacent to the m-th turn of the first wire on a side of the second flange in the direction along the central axis, an (m+1)-th turn of the first wire includes a portion that belongs to the first layer and is wound adjacent to the first portion on the side of the second flange in the direction along the central axis, an m-th turn of the second wire includes a portion that belongs to the second layer and is wound from the outside in the direction orthogonal to the central axis on a valley portion between the m-th turn of the first wire and the first portion, and an (m+1)-th turn of the second wire includes a portion that belongs to the second layer and is wound from the outside in the direction orthogonal to the central axis on a valley portion between the first portion and the (m+1)-th turn of the first wire.

[2] The coil component according to [1], in which all portions of the first wire wound around the winding core belong to the first layer.

[3] The coil component according to [1], in which an n-th turn (where m is an integer equal to or greater than 4, and n is an integer equal to or less than m−3) of the first wire includes a portion belonging to the first layer, an (n+1)-th turn of the first wire includes a portion that belongs to the first layer and is wound adjacent to the n-th turn of the first wire on the side of the second flange in the direction along the central axis, an (n+2)-th turn of the first wire includes a second portion that belongs to the second layer and is wound from the outside in the direction orthogonal to the central axis on a valley portion between the n-th turn of the first wire and the (n+1)-th turn of the first wire, and the second wire includes at least one or more turns wound on a side of the first flange with respect to the second portion in the direction along the central axis, and at least one or more turns wound on the side of the second flange with respect to the second portion in the direction along the central axis.

[4] The coil component according to [3], in which an n-th turn of the second wire includes a portion wound on a side of the first flange with respect to a n-th turn of the first wire in the direction along the central axis, and an (n+1)-th turn of the second wire includes a portion wound on the side of the second flange with respect to the (n+1)-th turn of the first wire in the direction along the central axis.

[5] The coil component according to [3] or [4], in which an (n+3)-th turn to the m-th turn of the first wire belong to the first layer and are sequentially wound so as to be located closer to the side of the second flange in the direction along the central axis as the number of turns increases, and an (n+1)-th turn to a middle of an (m−2)-th turn of the second wire belong to the second layer and are sequentially wound so as to be located closer to the side of the second flange in the direction along the central axis as the number of turns increases.

[6] A coil component including a winding core, a first flange provided at a first end of the winding core in a direction along a central axis, a second flange provided at a second end of the winding core opposite to the first end, a first external electrode and a second external electrode provided on the first flange, a third external electrode and a fourth external electrode provided on the second flange, a first wire wound around the winding core and having a first end connected to the first external electrode and a second end connected to the third external electrode, and a second wire wound around the winding core in a same direction as the first wire. The second wire has a first end connected to the second external electrode and a second end connected to the fourth external electrode, in which regarding the first wire and the second wire, a number of turns increases by one every time one turn is made around the central axis from the first end toward the second end. Also, when a portion directly wound around the winding core is defined as a first layer, and a portion wound from an outside of the first layer in a direction orthogonal to the central axis is defined as a second layer, a k-th turn (where k is a positive integer) of the first wire includes a portion belonging to the first layer, a (k+1)-th turn of the first wire includes a portion that belongs to the first layer and is wound adjacent to the k-th turn of the first wire on a side of the second flange in the direction along the central axis, a (k+2)-th turn of the first wire includes a second portion that belongs to the second layer and is wound from the outside in the direction orthogonal to the central axis on a valley portion between the k-th turn of the first wire and the (k+1)-th turn of the first wire, and the second wire includes at least one or more turns wound on a side of the first flange with respect to the second portion in the direction along the central axis, and at least one or more turns wound on the side of the second flange with respect to the second portion in the direction along the central axis.

What is claimed is:

1. A coil component comprising:
a winding core;
a first flange at a first end of the winding core in a direction along a central axis;
a second flange at a second end of the winding core opposite to the first end;
a first external electrode and a second external electrode on the first flange;
a third external electrode and a fourth external electrode on the second flange;
a first wire wound around the winding core and having a first end connected to the first external electrode and a second end connected to the third external electrode; and
a second wire wound around the winding core in a same direction as the first wire, the second wire having a first end connected to the second external electrode and a second end connected to the fourth external electrode,
wherein regarding the first wire and the second wire,
a number of turns increases by one every time one turn is made around the central axis from the first end toward the second end, and
when a portion directly wound around the winding core is defined as a first layer, and
a portion wound from an outside of the first layer in a direction orthogonal to the central axis is defined as a second layer,
an m-th turn (where m is an integer equal to or greater than 2) of the first wire includes a portion belonging to the first layer,
an (m−1)-th turn of the second wire includes a first portion that belongs to the first layer and is wound adjacent to the m-th turn of the first wire on a side of the second flange in the direction along the central axis,
an (m+1)-th turn of the first wire includes a portion that belongs to the first layer and is wound adjacent to the first portion on the side of the second flange in the direction along the central axis,
an m-th turn of the second wire includes a portion that belongs to the second layer and is wound from the outside in the direction orthogonal to the central axis on a valley portion between the m-th turn of the first wire and the first portion, and
an (m+1)-th turn of the second wire includes a portion that belongs to the second layer and is wound from the outside in the direction orthogonal to the central axis on a valley portion between the first portion and the (m+1)-th turn of the first wire.

2. The coil component according to claim 1, wherein
all portions of the first wire wound around the winding core belong to the first layer.

3. The coil component according to claim 1, wherein
an n-th turn (where m is an integer equal to or greater than 4, and n is an integer equal to or less than m−3) of the first wire includes a portion belonging to the first layer,
an (n+1)-th turn of the first wire includes a portion that belongs to the first layer and is wound adjacent to the n-th turn of the first wire on the side of the second flange in the direction along the central axis,
an (n+2)-th turn of the first wire includes a second portion that belongs to the second layer and is wound from the outside in the direction orthogonal to the central axis on a valley portion between the n-th turn of the first wire and the (n+1)-th turn of the first wire, and
the second wire includes at least one or more turns wound on a side of the first flange with respect to the second portion in the direction along the central axis, and at least one or more turns wound on the side of the second flange with respect to the second portion in the direction along the central axis.

4. The coil component according to claim 3, wherein
an n-th turn of the second wire includes a portion wound on a side of the first flange with respect to a n-th turn of the first wire in the direction along the central axis, and
an (n+1)-th turn of the second wire includes a portion wound on the side of the second flange with respect to the (n+1)-th turn of the first wire in the direction along the central axis.

5. The coil component according to claim 3, wherein
an (n+3)-th turn to the m-th turn of the first wire belong to the first layer and are sequentially wound so as to be closer to the side of the second flange in the direction along the central axis as the number of turns increases, and
an (n+1)-th turn to a middle of an (m−2)-th turn of the second wire belong to the second layer and are sequentially wound so as to be closer to the side of the second flange in the direction along the central axis as the number of turns increases.

6. The coil component according to claim 4, wherein
an (n+3)-th turn to the m-th turn of the first wire belong to the first layer and are sequentially wound so as to be closer to the side of the second flange in the direction along the central axis as the number of turns increases, and
an (n+1)-th turn to a middle of an (m−2)-th turn of the second wire belong to the second layer and are sequentially wound so as to be closer to the side of the second flange in the direction along the central axis as the number of turns increases.

7. A coil component comprising:
a winding core;
a first flange at a first end of the winding core in a direction along a central axis;
a second flange at a second end of the winding core opposite to the first end;
a first external electrode and a second external electrode on the first flange;
a third external electrode and a fourth external electrode on the second flange;
a first wire wound around the winding core and having a first end connected to the first external electrode and a second end connected to the third external electrode; and
a second wire wound around the winding core in a same direction as the first wire, the second wire having a first end connected to the second external electrode and a second end connected to the fourth external electrode,
wherein regarding the first wire and the second wire,
a number of turns increases by one every time one turn is made around the central axis from the first end toward the second end, and
when a portion directly wound around the winding core is defined as a first layer, and
a portion wound from an outside of the first layer in a direction orthogonal to the central axis is defined as a second layer,
a k-th turn (where k is a positive integer) of the first wire includes a portion belonging to the first layer,
a (k+1)-th turn of the first wire includes a portion that belongs to the first layer and is wound adjacent to the k-th turn of the first wire on a side of the second flange in the direction along the central axis,
a (k+2)-th turn of the first wire includes a second portion that belongs to the second layer and is wound from the outside in the direction orthogonal to the central axis on a valley portion between the k-th turn of the first wire and the (k+1)-th turn of the first wire, and
the second wire includes at least one or more turns wound on a side of the first flange with respect to the second portion in the direction along the central axis, and at least one or more turns wound on the side of the second flange with respect to the second portion in the direction along the central axis.
